(19) United States
(12) Patent Application Publication
(10) Pub. No.: US 2026/0141640 A1
(43) Pub. Date: May 21, 2026

(54) Annotation Free Three-Dimensional Reconstruction from Two-Dimensional Image

(71) Applicant: Sony Interactive Entertainment Inc., Toyoko (JP)

(72) Inventor: Chockalingam Ravi Sundaram, Fremont, CA (US)

(73) Assignee: Sony Interactive Entertainment Inc., Tokyo (JP)

(21) Appl. No.: 18/954,251

(22) Filed: Nov. 20, 2024

(51) Int. Cl. G06T 17/20; G06T 7/70; G06V 40/16

(52) U.S. Cl. CPC G06T 17/20; G06T 7/70; G06V 40/171; G06V 40/174

(57) ABSTRACT

Techniques for described for mesh generation. An example method can include accessing information indicating a first correspondence between a first three-dimensional landmark of a source three-dimensional face mesh representing a first face and a second three-dimensional landmark of a target three-dimensional head mesh representing a second face, the first three-dimensional landmark and the second three-dimensional landmark corresponding to a facial feature. The method can further include accessing a two-dimensional face image representing a third face, the two-dimensional face image further showing the facial feature. The method can further include generating a three-dimensional head mesh based on the two-dimensional face image and the correspondence between the first three-dimensional landmark and the three-dimensional second landmark, the three-dimensional head mesh representing a fourth face and including a first facial characteristic of the second face and a second facial characteristic of the third face.

### BACKGROUND

Three-dimensional modeling can include creating a digital representation of a human face in three-dimensions. The digital representation can be modified, animated and analyzed for various purposes. One example of 3D modeling is polygonal modeling, in which structures can be defined based on polygonal shapes, such as triangles or quadrilaterals. The polygonal shapes can collectively form a mesh that defines a surface of a three-dimensional object.

### BRIEF SUMMARY

The embodiments described herein describe techniques for three-dimensional head mesh generation from a two-dimensional image. The embodiments herein describe techniques for determining corresponding landmarks from of a facial representation and a head representation. The facial representation can be a representation of a real-world face. The head representation can include a video game character head to which a player may wish to deform their face's image. For example, a player may wish to play a video game, in which a protagonist or an antagonist resembles the player.

The corresponding landmarks can be determined without using the player's facial representation. Rather, a computer system can use a machine learning model to determine correspondences between a sample facial representation and a video game character head representation. A player can later request that a video display a character with the player's facial characteristics. The computer system can then access the correspondences between the landmarks and an image of the player's face. Based on the correspondences, the computer system can deform a three-dimensional face mesh of the player to the three-dimensional head mesh of the video game character. The three-dimensional head mesh can be integrated into the video game and the player can play the video game with the character's new head representation.

The embodiments herein described techniques for generating a three-dimensional mesh using mesh retargeting techniques. For example, the embodiments herein can be used to deform a head mesh of an existing video game character to a desired head mesh for a video game character. The desired head mesh can be used for the video game character for other player controllable characters or non-player characters (NPCs). Similar to above, a computer system can determine corresponding landmarks from of a first head representation (e.g., mesh) and a second head representation. The first and second head representations can include video game characters to which a user may wish to deform one video game character's face. In the event that a player wants to deform a head mesh, the computer system can access the corresponding landmarks to align a source head mesh and a target head mesh. The computer system can then deform the source head mesh based on the corresponding landmarks. The computer system can then generate a head mesh that can be integrated into a video game.

### BRIEF DESCRIPTION OF THE DRAWINGS

FIG. 1 is an illustration of an example computer system that presents a dashboard, according to one or more embodiments.

FIG. 2 is an illustration of an example computer system for generating paired three-dimensional landmarks, according to one or more embodiments.

FIG. 3 is an illustration of an example computer system for generating a target dimensional mesh, according to one or more embodiments.

FIG. 4 is an illustration of an example computer system for mesh defect correction, according to one or more embodiments.

FIG. 5 is an illustration of an example computer system for generating paired three-dimensional correspondences for mesh retargeting, according to one or more embodiments.

FIG. 6 is an illustration of an example computer system for generating paired three-dimensional correspondences for mesh retargeting, according to one or more embodiments.

FIG. 7 is an illustration of an example transformation from a two-dimensional (2D) image to a three-dimensional (3D) head mesh according to one or more embodiments.

FIG. 8 is an illustration of an example paired 3D correspondence according to one or more embodiments.

FIG. 9 is an illustration of an example mesh retargeting, according to one or more embodiments.

FIG. 10 is an illustration of example subsets, according to one or more embodiments.

FIG. 11 is an example process for mesh generation, according to one or more embodiments.

FIG. 12 is an example process for mesh retargeting, according to one or more embodiments.

FIG. 13 illustrates an example of a hardware system suitable for implementing a computer system, according to embodiments of the present disclosure

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Computing-assisted video game character creation can involve several stages. A computer system can execute three-dimensional modeling software to create a basic geometric shape representation of a character. This representation can be described as a base mesh. A mesh can be a collection of vertices, edges, and faces that can define the shape of a three-dimensional object. The computer system can further use digital sculpting tools to refine the base mesh and add details, such a unique facial structure, hair style, and other details. The computer system can further add texture details to refined mesh. The texture details can include skin color, clothing color, clothing patterns, and other texture details. The refined mesh can be wrapped around a virtual skeleton that can be used to control the movements of the refined mesh.

In some instances, a video game character's appearance can be altered. For example, the video game character's face can be modified to include characteristics of another face. For example, a computer system may receive a two-dimensional image of a face and be tasked with introducing characteristics of the face onto the head of a three-dimensional video game character. Conventional computer systems can rely on manual input for facial adjustments from artists who attempt to recreate facial features from a two-dimensional image onto a three-dimensional head of a video game character. Furthermore, various facial features, (e.g., eyes, nose, mouth, or other facial feature) of the two-dimensional image and the three-dimensional head may need manual annotating. This can be a time-consuming and computer-resource intensive endeavor.

The embodiments herein address the above-referenced issues by providing techniques for a pipeline that can process a two-dimensional face image and generate a three-dimensional head mesh. The herein-described techniques can be used for automated annotation of three-dimensional landmarks, where a landmark can be a point on a three-dimensional model that can be used for some operation, such as an alignment, scaling, or deformation. A landmark can include, for example, a tip of the nose, a corner of an eye, a joint, or other facial point. In terms of a mesh, the landmark can also be a vertex, an edge, or a face. The herein described techniques can include using the landmarks to reconstruct a first three-dimensional (3D) head mesh (e.g., video game character head mesh) into a second three-dimensional head mesh with facial characteristics from a two dimensional image (2D). The herein described techniques can further be used to determine defects, such as a defect at a vertex. In the instance that a defect is detected, the computer system can correct or mitigate the vertex to generate a more accurate head mesh.

The following example is provided for illustration purposes. A computer system can be configured to provide video game services. For example, a video game server can provide video game services, to one or more of handheld devices, video gaming consoles, or personal computers. The computer system can receive a two-dimensional image of a face. For example, the image can be that of a person who is playing a video game serviced by the computer system. The image can be accompanied by a request to generate a 3D head mesh to be used for a player controlled character or a non-player character (NPC). The request can be provided prior to gameplay or at some point during gameplay. The computer system can generate the three-dimensional head mesh based on the two-dimensional facial image. Therefore, even if the two-dimensional (2D) facial image only include facial portions (e.g., forehead, eyes, nose, mouth, chin, ears, or other facial portions) and does not include other portions of the head (e.g., back of the head, top of the head, hair features, or other portions of the head), the computer system can generate a three-dimensional head mesh that represents an entire head.

The three-dimensional head mesh can also include characteristics of both the face represented by the two-dimensional image and either the player controlled character or the NPC. For example, the computer system can provide services for the game God of War, which includes the player controlled character Kratos. Kratos can generally be described as having a muscular build and wearing ancient armor. Kratos's face can be described as rounded, bald headed, bearded, pale skin, brown eyes, and a red tattoo extend from his left eye down to his torso. The computer system can receive a two-dimensional image representing a video game player. The player's facial characteristics can include green eyes, no facial hair, a full head of black hair, and generally thin angled facial features. The image can be accompanied by a requests to generate a three-dimensional head mesh that incorporates facials features of the player and Kratos. The computer system can use the two-dimensional image of the player to generate a three-dimensional head mesh that incorporates the player's facial characteristics onto Kratos head. For example, the three-dimensional head mesh can cause Kratos to have black hair, less rounded and more angled features, and green eyes. However certain characteristics of a video game character may be synonymous with the character, such as Kratos's muscular build and red tattoo. The computer system can be configured to maintain these characteristics. Therefore, the three-dimensional head mesh can be generated to include these synonymous characteristics.

In the interest of clarity of explanation, the embodiments may be described in connection with a video game system including a video game console. However, the embodiments are not limited as such and similarly apply to any other type of a computer system. Generally, a computer system presents a dashboard in a GUI on a display. The dashboard presents UI elements, each corresponding to an application, service, or collection of information.

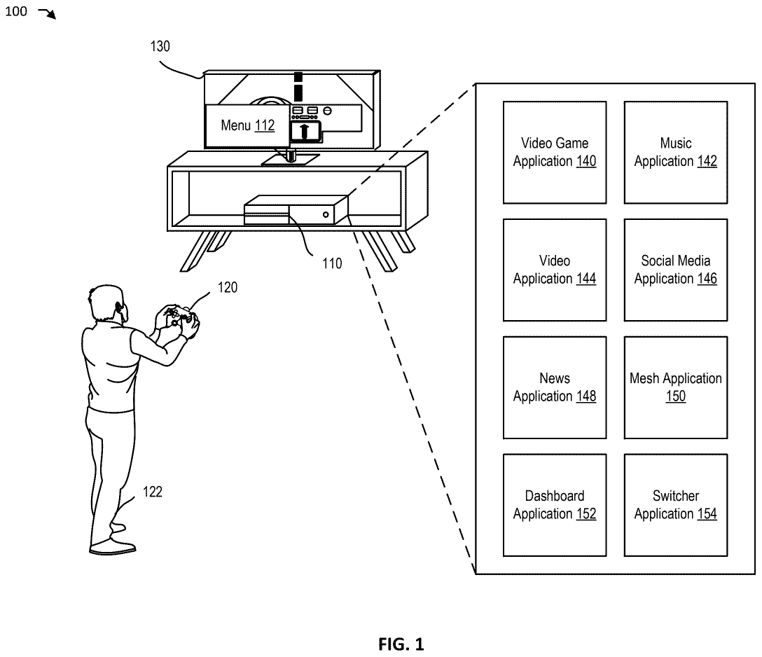

FIG. 1 is an illustration 100 of an example computer system that presents a dashboard, according to an embodiment of the present disclosure. As illustrated, the computer system includes a video game console 110, a video game controller 120, and a display 130. Although not shown, the computer system may also include a backend system, such as a set of cloud servers, that is communicatively coupled with the video game console 110. The video game console 110 is communicatively coupled with the video game controller 120 (e.g., over a wireless network) and with the display 130 (e.g., over a communications bus). A video game player 122 operates the video game controller 120 to interact with the video game console 110. These interactions may include playing a video game presented on the display 130, interacting with a menu 112 presented on the display 130, and interacting with other applications of the video game console 110 (e.g., with media applications to stream media from an online content source or to play a media file from the local storage of the video game console 110).

The video game console 110 includes a processor and a memory (e.g., a non-transitory computer-readable storage medium) storing computer-readable instructions that can be executed by the processor and that, upon execution by the processor, cause the video game console 110 to perform operations related to various applications. In particular, the computer-readable instructions can correspond to program codes for the various applications of the video game console 110 including video game application 140, music application 142, video application 144, social media application 146, and news application 148. A video game application, such as video game application 140, generally represents a computer application executable to present video game content, receive user interaction with the video game content, and accordingly update the video game content. A media application, such as music application 142, video application 144, social media application 146, and news application 148, generally represents a computer application executable to present media content including audio, video, and/or other media types, receive user interaction with the media content, and accordingly update the media content. The media content can be streamed from a remote content source or can be presented form local storage of the video game console 110. Further, other applications can be likewise included in the video game console 110, such as a chat application. The availability of a video game application, media application, and/or other type of computer application to the video game player 122 via the video game console 110 can depend on a user identifier of the video game player 122 (e.g., upon a login to the video game console 110, the availability of the computer applications can depend on the user identifier used in the login). In addition, the video game console 110 includes a mesh application 150, a dashboard application 152, and a switcher application 154. The mesh application 150 can present a home user interface (UI) in a GUI of the display 130. The dashboard application 152 can present an arrangement of interactive UI widgets in a dashboard page on the GUI. And the switcher application 154 can present a ribbon of UI elements in a ribbon menu on the GUI to allow scrolling between different UI elements and switching between corresponding applications.

The video game controller 120 is an example of an input device. The video game controller 120 may allow the user 122 to interact with one or more GUIs presented by the video game consol 110 on the display 130. For example, using one or more directional control inputs (e.g., a joystick and/or a directional pad) the user can navigate to and within various menus, dashboards, and UI elements. Other types of the input device are possible including, a keyboard, a touchscreen, a touchpad, a mouse, an optical system, a microphone, a camera, or other user devices suitable for receiving input of a user. For example, a microphone may allow the user 122 to interact with the GUIs using various voice commands. As another example, a camera may allow the user 122 to interact with the GUIs using various gesture commands.

Upon an execution of the video game application 140 by the video game console 110, a rendering process of the video game console 110 presents video game content (e.g., illustrated as a car race video game content) on the display 130. Upon user input from the video game controller 120 (e.g., a user push of a particular key or button), the rendering process also presents the menu 112. Additionally, or alternatively, the menu 112 may be presented as an initial landing page in response to a user powering-on the video game console 110 and/or waking the video game consol 110 from a suspended state. Depending on the user input, the menu 112 corresponds to the home UI page, a landing page, or the like. The menu 112 can be presented in a layer over the video game content.

Upon the presentation of the menu 112, the user control changes from the video game application 140 to the mesh application 150. Upon receiving a user input from the video game controller 120 requesting mesh generation or mesh retargeting, an underlying application (e.g., the mesh application 150) supports such interactions by generating a three-dimensional head mesh that can be used to present a character is a video game. The mesh application 150 can either use a 2D image or a three-dimensional mesh to generate a new three-dimensional mesh. The two-dimensional image can be captured by the camera, or the two-dimensional image can be accessed via one of the other applications (e.g., access an image from a social media site via the social media application). The three-dimensional mesh can be rendered into the video game content.

As described in more detail below, the dashboard application 152, when executed, may generate a dashboard (e.g., a “widget menu,” “landing page,” and/or “explore page”) configured to present information from applications and services available to the video game console 110 as interactive UI widgets. The term “widget” is used herein as an example of an interactive UI element generated and/or presented by the dashboard application 152 and corresponding to an application or service of the computer system. Other implementations to present a UI element are possible, including any type of icon, whether a widget, a tile, a thumbnail, a text description, a multiple column element with textual or graphical description in each column, and the like. As described further, below, widgets may be presented with application information and/or dynamic content presented with the widget in a media library. For example, the dashboard application 152 may generate and/or present widgets associated with media applications, system applications and/or services, video game applications, or the like.

As described in more detail below, the dashboard application 152 may be executed via multiple avenues of ingress. For example, the dashboard application 152 may be executed by a pre-defined user interaction (e.g., via controller 120, a voice command from the video game player 122, activating and/or powering-on the video game consol 110 etc.) and/or by navigating one or more menus and/or sub-menus of the video game console 110 (e.g., menu 112).

In general, the switcher application 154 may facilitate selection of a first subset of tiles to present in an immediate selection area of a library interface, as described in more detail below. The switcher application 154 may populate the first subset of tiles with tiles associated with system applications, video game applications, other forms of content, etc.

Although FIG. 1 illustrates that the different applications are executed on the video game console 110, the embodiments of the present disclosure are not limited as such. Instead, the applications can be executed on the backend system (e.g., the cloud servers) and/or their execution can be distributed between the video game console 110 and the backend system.

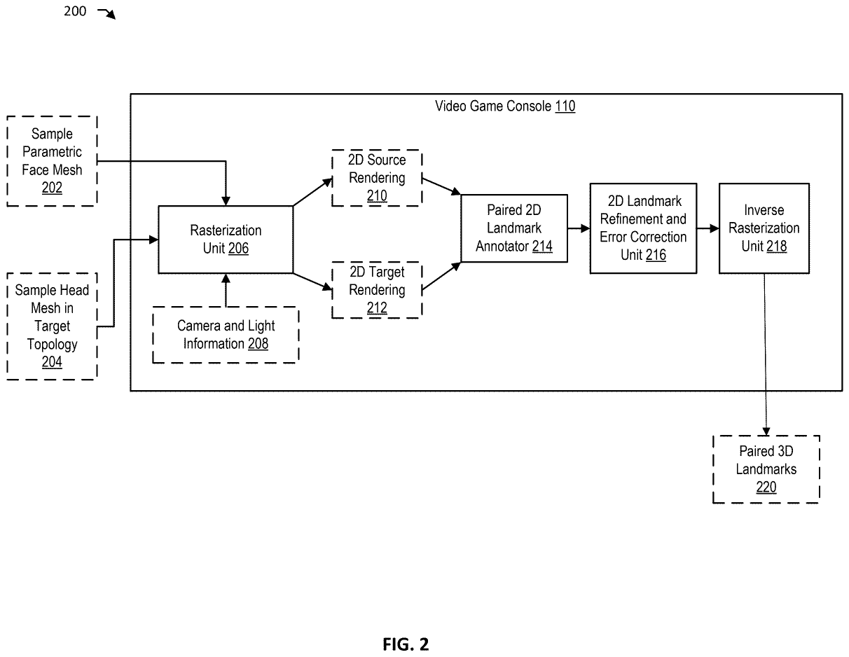

FIGS. 2-6 are provided to describe different mesh generation functions that can be performed. One of more of the processes described in FIGS. 2-6 can be used generate a three-dimensional mesh for rending an image onto a video game.

FIG. 2 is an illustration 200 of an example computer system for generating paired three-dimensional landmarks, according to one or more embodiments. The process described with respect to FIG. 2 can be managed by the mesh application 150. It should be appreciated that although described in the context of the video game console 110, one or more of the functions described herein can be performed by a server that is remote from the video game console 110. As described herein, the video game console 110 can be configured to access a source image of a face (e.g., real-world face) and generate a three-dimensional head mesh that includes facial characteristics of both the source image and another face (e.g., video game character face). The transformation from the source image to the three-dimensional head mesh can be based on pairings of three-dimensional landmarks on the source face and the target face. For example, the pairing can include a tip of a right eye on the source face, and a tip of a right eye on the target face. The pairings can be used to align a first three-dimensional head mesh generated based a two-dimensional image and a second three-dimensional image of a video game character. The vertices of a three-dimensional mesh based on a player's face can be deformed to the vertices of a target three-dimensional mesh of a video game character to generate a blended three-dimensional mesh that includes facial characteristics of the player and the video game character. As described herein, the video game console 110 can learn the pairings between facial landmarks during a first pass through using a sample source image and a sample target image. Once the video game console 110 learns the three-dimensional pairings, it can use this knowledge to determine three-dimensional pairings between landmarks of subsequent faces. In this sense, the video game console can access different images and meshes without having to relearn the pairings of the three-dimensional landmarks.

The video game console 110 can access a sample parametric face mesh 202 and a sample head mesh in target topology 204. The sample parametric face mesh 202 can be a face mesh generated from an image (an image of a real-world person, an image of a computer generated character). The sample head mesh in target topology 204 can be a face mesh generated from a video game character. Each of the sample parametric face mesh 202 and the sample head mesh in target topology 204 can be three-dimensional representations. The rasterization unit 206 can process the sample parametric face mesh 202 and the sample head mesh in target topology 204 to transform the three-dimensional representations into two-dimensional representations. The rasterization unit 206 can transform the vertices of the sample parametric face mesh 202 and the sample head mesh in target topology 204 into a joint 3D space. The rasterization unit 206 can then project the 3D sample parametric face mesh 202 onto a 2D space to generate a 2D source rendering 210 (e.g., 2D source facial rendering) based on the coordinates of the joint 3D space. The rasterization unit 206 can also project the 3D sample head mesh in target topology 204 onto the 2D space to generate a 2D target rendering 212 (e.g., 2D target facial rendering) based on the coordinates of the joint 3D space.

In some instances, the rasterization unit 206 can access camera and light information 208 to assist with projecting the 3D representations onto 2D representations. For example, the camera and light information 208 that are used when capturing one or both of the sample parametric face mesh 202 and the sample head mesh in target topology 204 can affect how the computer system perceives these meshes. For example, objects that are farther from a camera lens can be perceived as smaller. In another example, the way the lighting interacts with the surface of an object can affect how the object (e.g., surface texture, surface shape) is perceived by a camera. This information can be used to determine the projection of the 3D representations onto the 2D representations.

A paired 2D landmark annotator 214 can access the 2D source rendering 210 and the 2D target rendering 212. A landmark can be a respective point on the 2D source rendering 210 and the 2D target rendering 212 that can be used some operation, such as an alignment, scaling, or deformation. For example, each of the 2D source rendering 210 and the 2D target rendering 212 can be renderings that include faces. Each face can include, for example, a left eye and a right eye. The paired two-dimensional landmark annotator 214 can include a machine learning model (e.g., a convolutional neural network (CNN) or other neural network) that is trained to identify landmarks. The paired two-dimensional landmark annotator 214 can be configured with pre-determined landmarks to be identified (e.g., a corner of an eye, a tip of the nose, a base of the chin) for each of the 2D source rendering 210 and the 2D target rendering 212. The paired two-dimensional landmark annotator 214 can further identify the coordinates of the landmarks on each of the 2D source rendering 210 and the 2D target rendering 212. For example, coordinates of a corner of a left eye on the 2D source rendering 210 can be denoted as (x1, y1). Furthermore, coordinates of a corner of a left eye on the 2D target rendering 212 can be denoted as (x2, y2). The paired two-dimensional landmark annotator 214 can further pair the coordinates with each other to create a mapping from a landmark of the 2D source rendering 210 to a corresponding landmark of the 2D target rendering 212. The mapping can further include a directional information for moving the location of the coordinate (x1, y1) to the location of the coordinate (x2, y2). This information can be used to deform the vertices of a face mesh as described herein.

A 2D refinement and error correction unit 216 can access the coordinate pairing information from the paired two-dimensional landmark annotator 214 to determine whether there have been any errors. The error can include determinations of landmark coordinates that may not be correct. For example, the 2D refinement and error correction unit 216 can be configured to include general regions in which landmark may be located. For example, a location of a corner of left eye may be in a region that is to the left of a region for a corner of left eye. The 2D refinement and error correction unit 216 can have a configuration for a real-world meshes and computer generated meshes (e.g., video game, animation, or other computer generated faces). The regions for different landmarks may be different based on whether the image is a real-world image (e.g., real-world face image) or a computer generated image. For example, the eye regions for a real-world mesh may be located differently than the eye regions for a computer-generated mesh.

The 2D refinement and error correction unit 216 can determine whether there are any landmarks that have been located in the incorrect position. For example, the 2D refinement and error correction unit 216 can determine whether any landmark is located outside of a corresponding region. In another example, the 2D refinement and error correction unit 216 can determine whether the location of the corner of the left eye was determined to be to the right of the corner of the righteye. In another example, the 2D refinement and error correction unit 216 can determine whether a landmark of the 2D source rendering 210 was paired with an incorrect landmark of the 2D target rendering 212. For example, the tip of the nose of the 2D source rendering 210 should correspond to the tip of the nose of the 2D target rendered 212. Therefore, if one of the tips of the nose corresponds to, for example, a corner of a lip, there may be an error in the landmark pairings.

The 2D refinement and error correction unit 216 can detect these errors in either landmark location or landmark pairing and correct these errors. For example, the 2D refinement and error correction unit 216 can cause the paired 2D landmark annotator 214 to reassess the location of landmark and cause the search space to be reduced to only a region (e.g. lip region) that corresponds to the landmark (e.g., corner of lip). The 2D refinement and error correction unit 216 can also cause the paired 2D landmark annotator 214 to reassess a landmark pairing, and cause the search space to be reduced to particular landmark type (e.g., landmarks located at the lip or other landmark types).

The inverse rasterization unit 218 can access information from the 2D landmark refinement and error correction unit 216 to generate a three-dimensional paired landmarks. For example, the inverse rasterization unit 218 can use an edge detection technique to determine the respective edges of the 2D source rendering 210 and the 2D target rendering 212. The edge detecting techniques can also be used to determine mesh vertices and edges. The inverse rasterization unit 218 can also respectively trace a contour of the edges to form continuous lines across the 2D source rendering 210 and the 2D target rendering 212. The inverse rasterization unit 218 can then determine a location of the 2D landmarks in the 3D space. The inverse rasterization unit 218 can them generate a mapping between each landmark location in the 3D space to a corresponding landmark (e.g., a left corner of eye to a left corner of eye) to generate the paired 3D landmarks 220.

The paired 3D landmarks 220 can be reusable in that the pairing can be used for landmark pairs for different 3D face meshes than the sample parametric face mesh 202 and the sample head mesh in target topology 204. The paired 3D landmarks 220 can be reusable in that the pairing can be used for landmark pairs for different 2D renderings than the 2D source rendering 210 and the 2D target rendering 212.

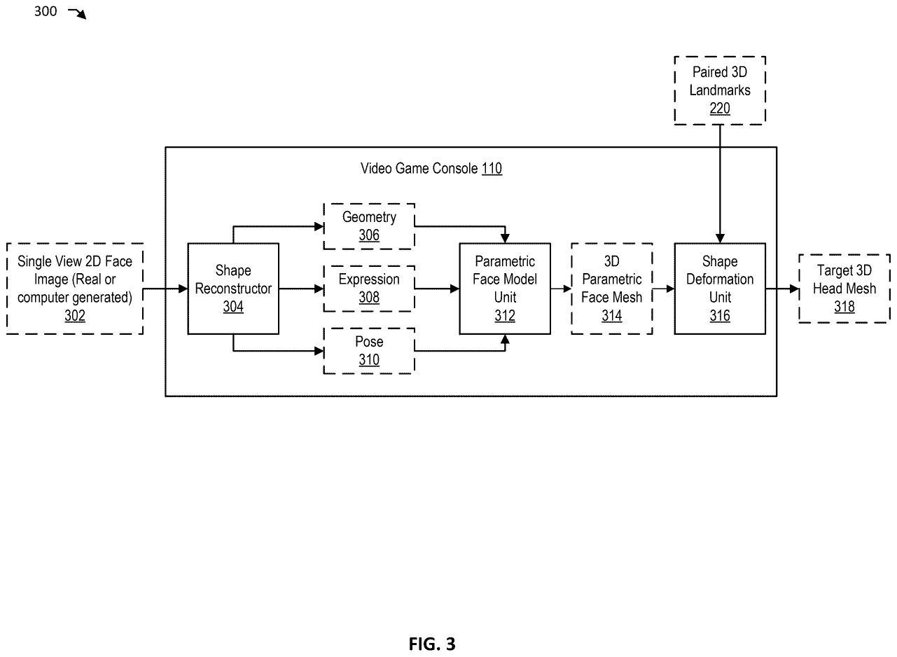

FIG. 3 is an illustration 300 of an example computer system for generating a target dimensional mesh, according to one or more embodiments. It should be appreciated that although the video game console 110 is illustrated, the functionality can be performed by any video game console or server that can access the paired 3D landmarks 220.

The video game console 110 can access a single view 2D face image 302. The image can be a real-world image or a computer generated image. In some instances, the image can include the face without other portions of the head (e.g., top of the head, sides of the head, back of the head). A shape reconstructor 304 can include a machine learning model (e.g., a CNN or other neural network). The shape reconstructor 304 can be trained to determine various facial parameters from the single view 2D face image 302. These features can include, for example, a geometry 306, an expression 308, and a pose 310. The geometry 306 can include a spatial arrangement of facial landmarks within the plane of the image. The geometry can also include spatial relationships between different landmarks (e.g., inner eye distance, facial symmetry, and other spatial relationships). The expression 308 can include various facial expressions (smiling, scowling, or other expression) that can affect perception of the single view 2D face image 302 and generation of a three dimensional representation. The pose 310 can include a relative position of the face in relation to an image capturing device that captured the single view 2D face image 302 or an observer. The pose 310 can include a yaw information for rotation around a vertical axis, pitch information for rotation around a horizontal axis, and roll information for axis perpendicular to the face.

The information relating to the geometry 306, the expression 308, and the pose 310 can be access by a parametric face model unit 312 that can reconstruct a 3D parametric face mesh 314. The 3D parametric face mesh 314 can include a model that represents the 3D features of the face. The 3D parametric face mesh 314 can include the vertices that define a facial structure, the edges that connect pairs of vertices and form a mesh framework, and faces that are triangles or quadrilaterals that are formed by the edges. The 3D parametric face mesh 314 can be a low mesh resolution and be a face mask that does not include a full three hundred and sixty degree head model. As such, this 3D parametric face mesh 314 may not be usable by a video game application.

A shape deformation unit 316 can access the 3D parametric face mesh 314 and the paired 3D landmarks 220. The shape deformation unit 316 can determine the 3D landmark locations in the 3D parametric face mesh 314. The shape deformation unit 316 can further determine the corresponding facial landmarks for a target head mesh based on the paired 3D landmarks 220. This information can include a mapping between locations of paired 3D landmarks. The shape deformation unit 316 can then deform the 3D parametric face mesh 314 to cause the location of the landmarks on the 3D parametric face mesh 314 to match the locations of the corresponding landmarks as indicated by the paired 3D landmarks. For example, returning to the example of Kratos from the God of War game. The single view 2D face image 302 can be a real-world image of a video game player or an avatar image of the video game player. The sample head mesh in target topology 204 can have been a head mesh representing the head of Kratos. The shape deformation unit 316 can deform the landmarks from the 3D parametric face mesh 314 representing the player to the landmarks of the head of Kratos. The resulting target 3D head mesh 318 can have the characteristics of the player or the player's avatar and Kratos. The video game console 110 can be configured to store information certain synonyms characteristics for each video game character. For example, video game console 110 can store information regarding Kratos's scar or Elie's scowl from the Last of Us. The video game console 110 can be configured to indicate the edges, faces, or vertices associated with these characteristics and generate a three-dimensional head mesh that preserves these characteristics.

The herein described embodiments can also include defect correction techniques.

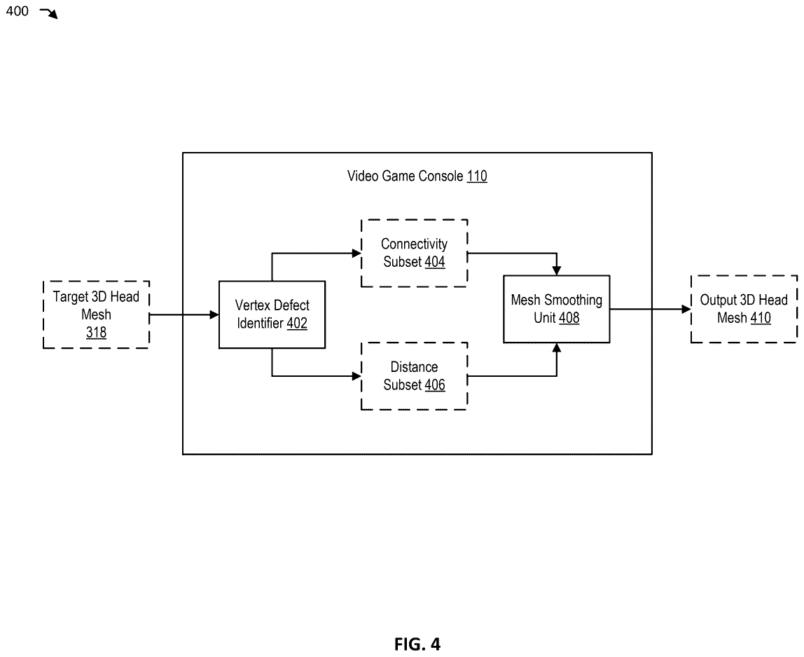

FIG. 4 is an illustration 400 of an example computer system for mesh defect correction, according to one or more embodiments. It should be appreciated that although the video game console 110 is illustrated, the functionality can be performed by any video game consol or server that can access the target 3D head mesh 318.

A vertex defect identifier 402 can access the target 3D head mesh 318 based on thresholding. For example, the vertex defect identifier 402 can determine whether a vertex associated with a landmark region (e.g., a region associated with a right corner of an eye or other landmark region). If the vertex is located outside the region, then an error can be detected. In another example, the locations of the vertex can be compared to a reference 3D head mesh (e.g., from a reference two-dimensional representation or reference three-dimensional representation). Based on the comparison, the vertex defect identifier 402 can determine a defect at one or more vertex. The vertex defect identifier 402 can then correct or mitigate a region surrounding the vertex. The region can be determined by a connectivity or a distance. A connectivity subset 404 can include each vertex that is connected to the vertex that had a defect. Vertices can be connected by edges. For example, vertex A is connected to vertex B via edge C, and vertex B can be connected to vertex D via edge E. Therefore, the connectivity subset 404 can include all vertices within a threshold number of edges. For example, if the threshold is one edge, the connectivity subset 404 can include vertex A and vertex B. If the threshold is two edges, the connectivity subset can include vertex A, vertex B, and vertex D. A distance subset 406 can include are vertices that are within a threshold distance (e.g., two centimeters, three centimeters, or other distance) of the defect vertex.

The mesh smoothing unit 408 can access the connectivity subset 404 or the distance subset 406. The mesh smoothing unit 326 can determine the positions of the vertices in the access the connectivity subset 404 or the distance subset 406. The mesh smoothing unit 408 can determine average positions of the vertices. For example, the mesh smoothing unit 408 can use a weighted scheme to determine the average positions of the vertices. The mesh smoothing unit 408 can then move the vertices to the determined average positions. This can be an iterative process that is repeated multiple times. The mesh smoothing unit 408 can then output a 3D head mesh 410, which can include a three-dimensional representation of the entire head. The 3D head mesh can be a high resolution, high fidelity, representation of a head (e.g., a head that incorporates features of a real-world face image and a video game character face image).

The description above have related to generating a three-dimensional head mesh of a video game character from a two-dimensional image of a real-world person. It should be appreciated that the embodiments herein can be used for different scenarios. For example, the embodiments herein can be used to transform a generate a three-dimensional head mesh for a video game character from a two dimensional image of a video game character. For example, the sample head mesh in target topology 204 can be a head mesh for Nathan Drake from the Uncharted series. Furthermore, the single view 2D face image 302 can be an image of Joel from the Last of Us. The video game console 110 can generate a three-dimensional head mesh that includes the facial characteristics of both Nathen Drake and Joel. Another example scenario can include generating a three-dimensional head mesh for an avatar (e.g., a virtual assistant avatar). For example, the sample head mesh in target topology 204 can be a head mesh for a reference avatar. Furthermore, the single view 2D face image 302 can be an image of a user. The video game console 110 can generate a three-dimensional head mesh that includes the facial characteristics of both the reference avatar and the user.

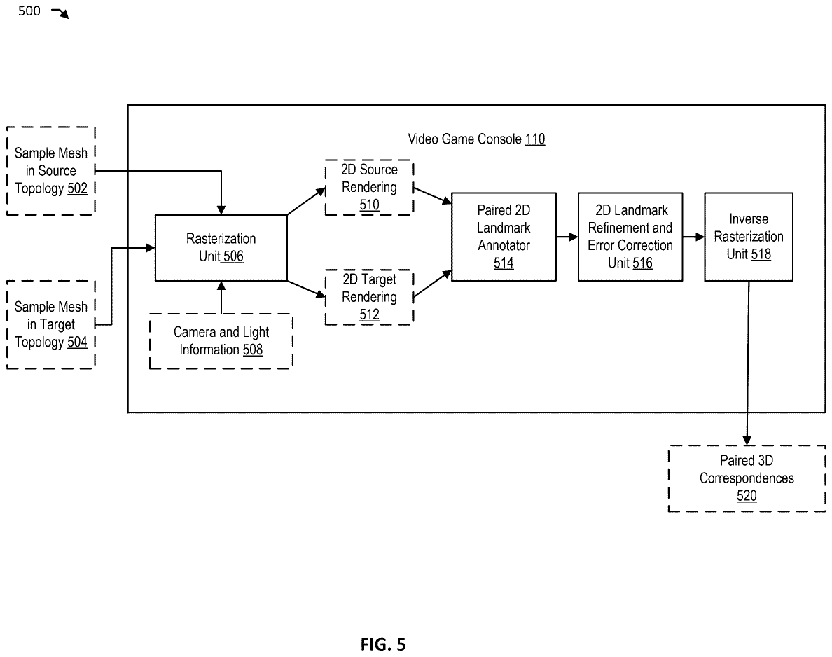

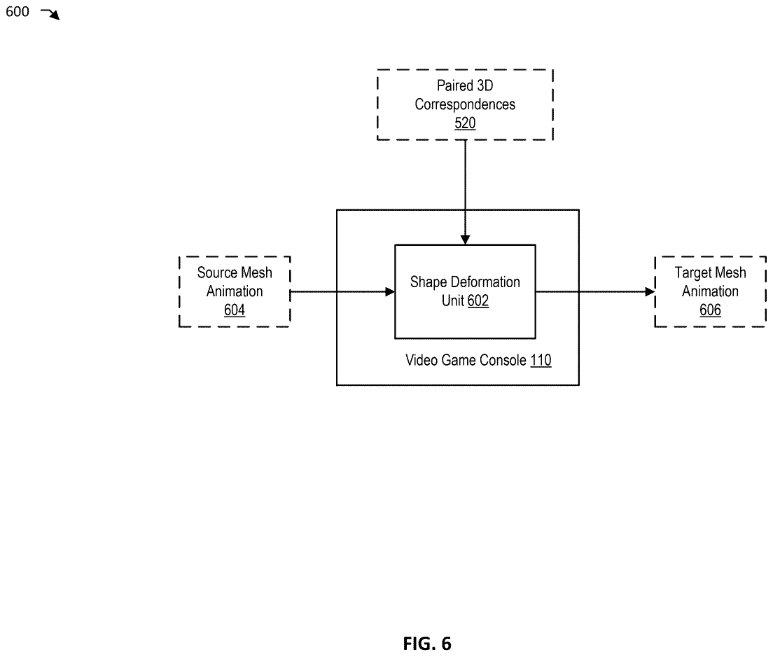

Mesh retargeting can include adapting one mesh to fit another mesh. Mesh retargeting can allow the reuse of animations or models for video games. The following paragraphs and FIGS. 5 and 6 describe techniques for mesh retargeting.

FIG. 5 is an illustration 500 of an example computer system for generating paired three-dimensional correspondences for mesh retargeting, according to one or more embodiments. The mesh retargeting process described with respect to FIG. 5 can be managed by the mesh application 150. It should be appreciated that although described in the context of the video game console 110, one or more of the functions described herein can be performed by a server that is remote from the video game console 110.

The video game console 110 can access a sample mesh in source topology 502 and a sample mesh in target topology 504. The sample mesh in source topology 502 can be a 3D face mesh generated from either a real-world image or a video game image. sample mesh in target topology 504 can be a 3D face mesh generated from a video game character. The rasterization unit 506 can process the sample mesh in source topology 502 and the sample mesh in target topology 504 to transform the three-dimensional representations into two-dimensional representations similar to as described above.

In some instances, the rasterization unit 506 can access camera and light information 208 to assist with projecting the 3D representations onto 2D representations. This information can be used to determine the projection of the 3D representations to the 2D representations as described above.

A paired 2D landmark annotator 514 can access the 2D source rendering 510 (e.g., 2D source facial rendering) and the 2D target rendering 512 (e.g., target 2D facial rendering). The paired two-dimensional landmark annotator 514 can include a machine learning model (e.g., a convolutional neural network (CNN) or other neural network) that is trained to identify landmarks. The paired two-dimensional landmark annotator 514 can be configured with pre-determined landmarks to be identified for each of the 2D source rendering 510 and the 2D target rendering 512. The paired two-dimensional landmark annotator 514 can further identify the coordinates of the landmarks on each of the 2D source rendering 510 and the 2D target rendering 512. The paired two-dimensional landmark annotator 514 can further pair the coordinates with each other to create a mapping from a landmark of the 2D source rendering 510 to a corresponding landmark of the 2D target rendering 512.

A 2D refinement and error correction unit 516 can access the coordinate pairing information from the paired two-dimensional landmark annotator 514 to determine whether there have been any errors. The error can include determinations of landmark coordinates that may not be correct as described above.

The 2D refinement and error correction unit 216 can determine whether there are any landmarks that have been located in an incorrect position. In another example, the 2D refinement and error correction unit 216 can determine whether a landmark of the 2D source rendering 210 was paired with an incorrect landmark of the 2D target rendering 212. The 2D refinement and error correction unit 216 can detect these errors in either landmark location or landmark pairing and correct these errors as described above.

The inverse rasterization unit 518 can access information from the 2D landmark refinement and error correction unit 516 to generate a paired 3D correspondences 520. The paired 3D correspondences 520 can be the similar to the paired 3D landmarks 220, but used for mesh retargeting. The inverse rasterization unit 518 can determine a location of the 2D landmarks in the 3D space. The inverse rasterization unit 518 can then generate a mapping between each landmark location in the 3D space to a corresponding landmark to generate the paired 3D correspondences 520.

The paired 3D correspondences 520 can be reusable in that the pairing can be used for landmark pairs for different 3D face meshes.

FIG. 6 is an illustration 600 of an example computer system for generating paired three-dimensional correspondences for mesh retargeting, according to one or more embodiments. It should be appreciated that although the video game console 110 is illustrated, the functionality can be performed by any video game console or server that can access the paired 3D correspondence 520.

A shape deformation unit 602, which can the same as the shape deformation unit 316 can access the paired 3D correspondence 520 and a source mesh animation 604. The source mesh animation 604 can be a high resolution animation that is or can be used in a video game. The paired three correspondences can include a mapping from a source head landmarks (e.g., real-world head landmarks) to a target head landmarks, such as landmarks on a video game character's head (e.g., Kratos's head or some other characters head). The shape deformation unit 602 can deform the source mesh animation 604 by moving the landmark on the source mesh animation to new locations based on the target head landmarks indicated in the paired 3D correspondences as described above. The resulting target mesh animation 606 can be a high resolution mesh that can be used in a video game and has characteristic features of a source face and a target face.

The description above have related to mesh retargeting from a video game character. It should be appreciated that the embodiments herein can be used for different scenarios. For example, the embodiments herein can be used to transform to mesh retargeting for real-world images. For example, the source mesh animation 604 can be for a real-world image. Furthermore, the sample mesh target topology 504 can also be a real-world image. The video game console 110 can generate a three-dimensional head mesh that includes the facial characteristics of both real-world images. One having ordinary skill in the art can contemplate various other scenarios, such as a sample mesh target topology 504 can being a video game character mesh and the source mesh animation 604 being a real-world image. This can result in a three-dimensional mesh that primarily appears to be a real world image, but with video game character characteristics. For example, a three-dimensional mesh that resembles a real-world image, but with hair like Aloy from the Horizon series.

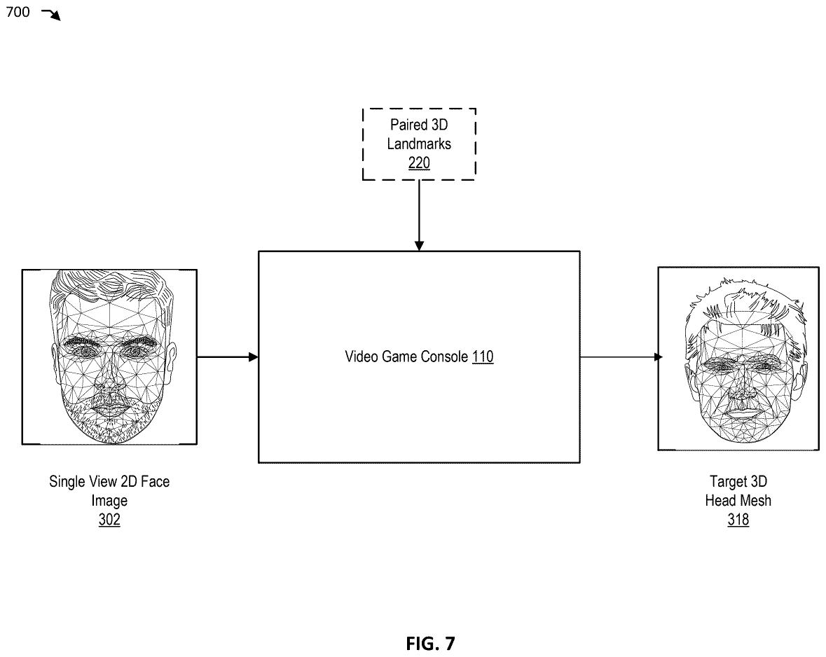

FIGS. 7-10 are provided to illustrate various features described above. FIG. 7 is an illustration 700 of an example transformation from a 2D image to a 3D head mesh according to one or more embodiments. A video game console 110 can access a single view 2D face image 302. As illustrated, the single view 2D face image 302 can include an image of a male face who has curly dark hair, a beard, and dark eyebrows. The video game console 110 can further access paired 3D landmarks 220. It should be appreciated that the paired 3D landmarks 220 can be generated without use of the single view 2D face image 302. Rather the paired 3D landmarks 220 can be generated using a sample parametric face mesh 202 and a sample head in target topology, which can be associated with a video game character.

As described above, the video game console 110 can generate a target 3D head mesh 318 based on the single view 2D face image 302 and the paired 3D landmarks 220. The target 3D head mesh 318 can have the characteristics of the single view 2D face image 302 and a video game character. For example, both the single view 2D face image 302 and a video game character can have the same lip structure. The video game character may have characteristic more rounded face. As illustrated, the target 3D head mesh 318 head has a rounded face.

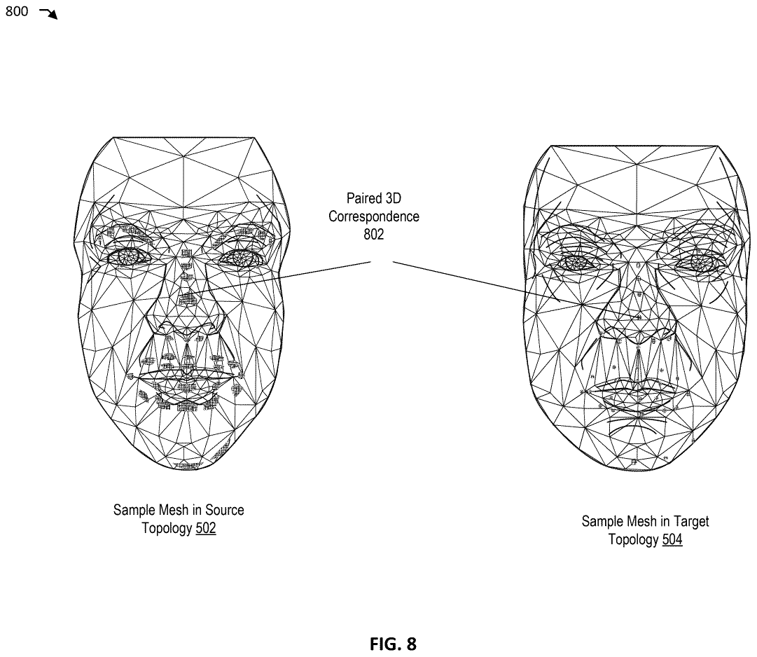

FIG. 8 is an illustration 800 of an example paired 3D correspondence according to one or more embodiments. A sample mesh in source topology 502 and a sample mesh in target topology 504 are illustrated. As illustrated each topology is different in that each has a different number of vertices, edges, and faces. Each of the source topology 502 and a sample mesh in target topology 504 have various landmarks indicated. For illustrated a pair of paired 3D landmarks correspondence 802 has been illustrated. Each corresponds to a tip of the nose. There can be a mapping from the tip of the nose landmark on the sample mesh in source topology 502 to the tip of the nose landmark on the sample mesh in target topology 504. The mapping can guide a deformation process from a source 3D head mesh to a target 3D head mesh as described above.

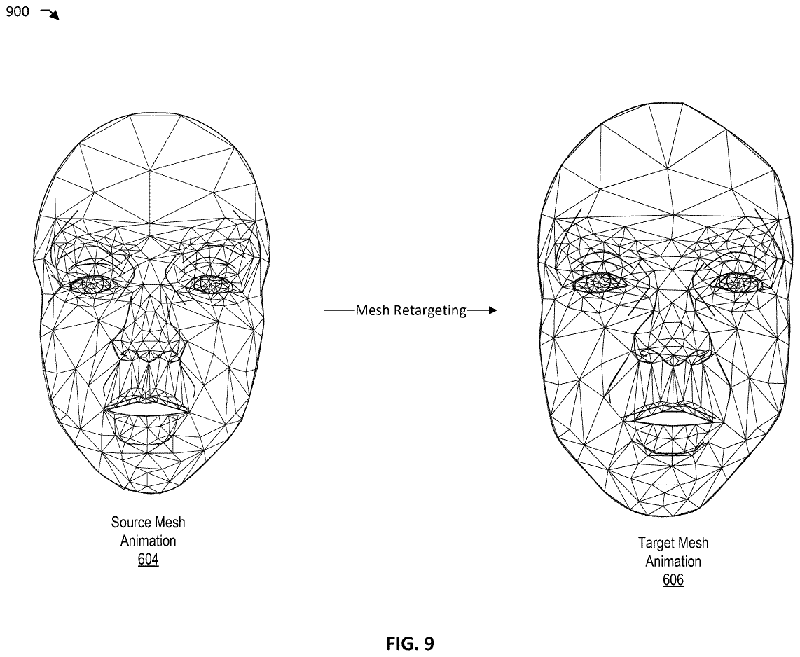

FIG. 9 is an illustration 900 of an example mesh retargeting, according to one or more embodiments. As illustrated a source mesh animation 604 has been deformed via mesh retargeting to include a target mesh animation. It is illustrated that the facial structure of the source mesh animation has been deformed from a thinner facial structure to a more rounded facial structure. However, even with the changes in the facial structure, it is illustrated that both faces are frontward facing, both eyes are open, and the mouth is open. Therefore, by incorporating the paired 3D correspondences 520, the pose and the expression of the source mesh animation can remain the same.

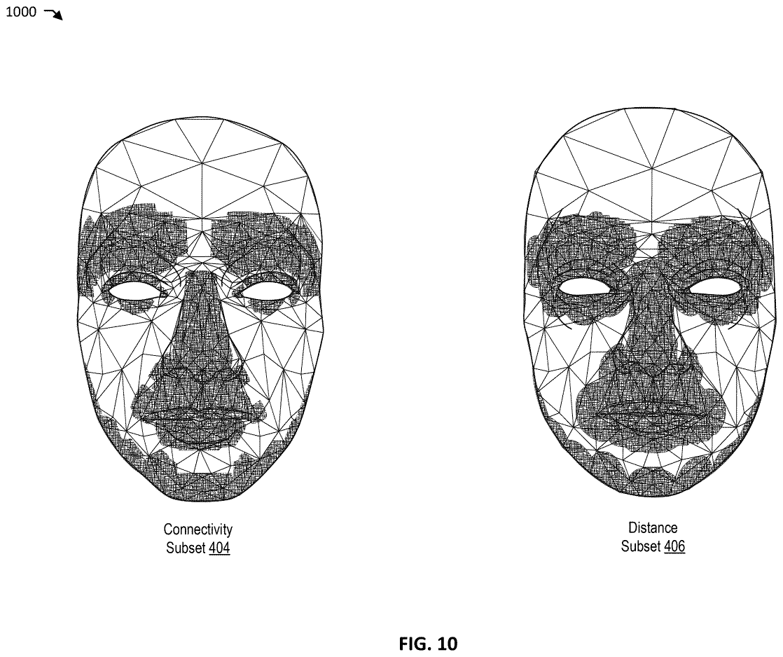

FIG. 10 is an illustration 1000 of example subsets, according to one or more embodiments. As illustrated a 3D face mesh with connectivity subsets 404 illustrated as darkened regions. The same 3D face mesh is illustrated with distance subsets 406 in darker regions. A video game console 110 can determine that a vertex has a defect. As illustrated, the video game console can determine that a respective vertex around a left eye region, a right eye region, a nose region, a mouth region and a chin region have an error. It is illustrated that even though both 3D face meshes have vertexes with defects in the same regions, different areas can be selected for a smoothing operation. Therefore, depending on whether a mesh smoothing unit 408 accesses the connectivity subset 404 or the distance subset 406, different regions of a 3D mesh are smoothed.

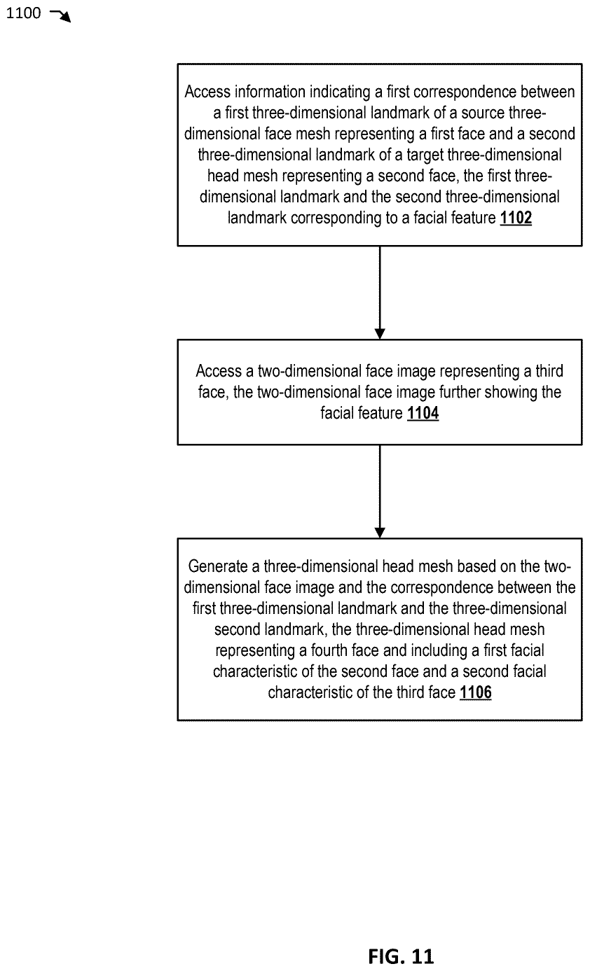

FIG. 11 is an example process 1100 for mesh generation, according to one or more embodiments. At 1102, the process 1100 can include a video game console (e.g., video game console 110) accessing information indicating a first correspondence (e.g., paired 3D correspondences 220) between a first three-dimensional landmark of a source three-dimensional face mesh (e.g., 3D representation of a sample parametric face mesh 202) representing a first face and a second three-dimensional landmark of a target three-dimensional head mesh (e.g., 3D representation of sample head mesh in target topology) representing a second face, the first three-dimensional landmark and the second three-dimensional landmark corresponding to a facial feature. The facial feature can include, for example, corner of eye, a tip of the nose or other facial feature. This can be a feature used to align two or more meshes. To align the meshes, each should include the same facial feature.

At 1104, the process 1100 can include accessing a two-dimensional face image (e.g., single view 2D face image 302) representing a third face, the two-dimensional face image further showing the facial feature. The two-dimensional face image can show the face that is to be deformed to a video game character's face.

At 1106, the process 1100 can include generating a three-dimensional head mesh (e.g., target 3D head mesh 318) based on the two-dimensional face image and the correspondence between the first three-dimensional landmark and the three-dimensional second landmark, the three-dimensional head mesh representing a fourth face and including a first facial characteristic of the second face and a second facial characteristic of the third face. Therefore, if the 2D image is a real-world image, and the target three-dimensional head mesh is a video game character, the three-dimensional head mesh can include a 3D head mesh for a video game character with facial characteristic from the 2D face image. As indicated above, the process 1100 can also include preserving certain characteristics of a video game character for the 3D head mesh. The examples included above, include Kratos's tattoo and Aloy's hair style.

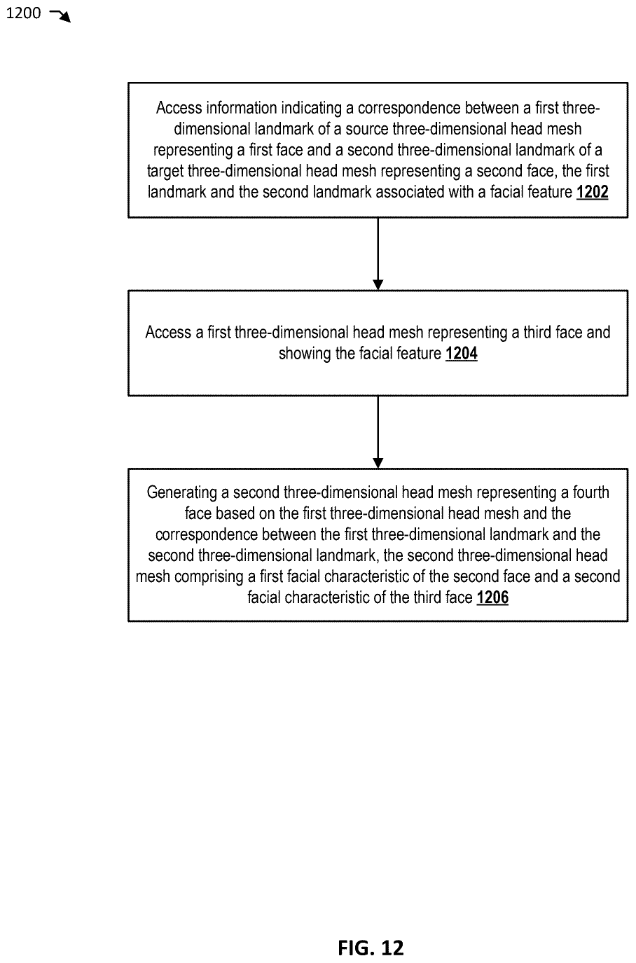

FIG. 12 is an example process 1200 for mesh retargeting, according to one or more embodiments. At 1202, the process 1200 can include a video game console (e.g., video game console 110) accessing information indicating a correspondence (e.g., paired 3D correspondences 520) between a first three-dimensional landmark of a source three-dimensional head mesh (e.g., 3D representation of sample mesh in source topology 502) representing a first face and a second three-dimensional landmark of a target three-dimensional head mesh (e.g., 3D representation of sample mesh in target topology 504) representing a second face, the first landmark and the second landmark associated with a facial feature. The facial feature can include, for example, corner of eye, a tip of the nose or other facial feature. To align the meshes, each should include the same facial feature.

At 1204, the process 1200 can include the video game console accessing a first three-dimensional head mesh (e.g., source mesh animation 604) representing a third face and showing the facial feature. The first three-dimensional head mesh can be the mesh that is to be deformed.

At 1206, the process 1200 can include the video game console generating a second three-dimensional head mesh representing a fourth face based on the first three-dimensional head mesh and the correspondence between the first three-dimensional landmark and the second three-dimensional landmark, the second three-dimensional head mesh comprising a first facial characteristic of the second face and a second facial characteristic of the third face. Therefore, if the first three-dimensional head mesh is a first video game character, and the target three-dimensional head mesh is a second video game character, the second three-dimensional head mesh can include a 3D head mesh for a video game character with facial characteristic from both the first video game character and the second video game character.

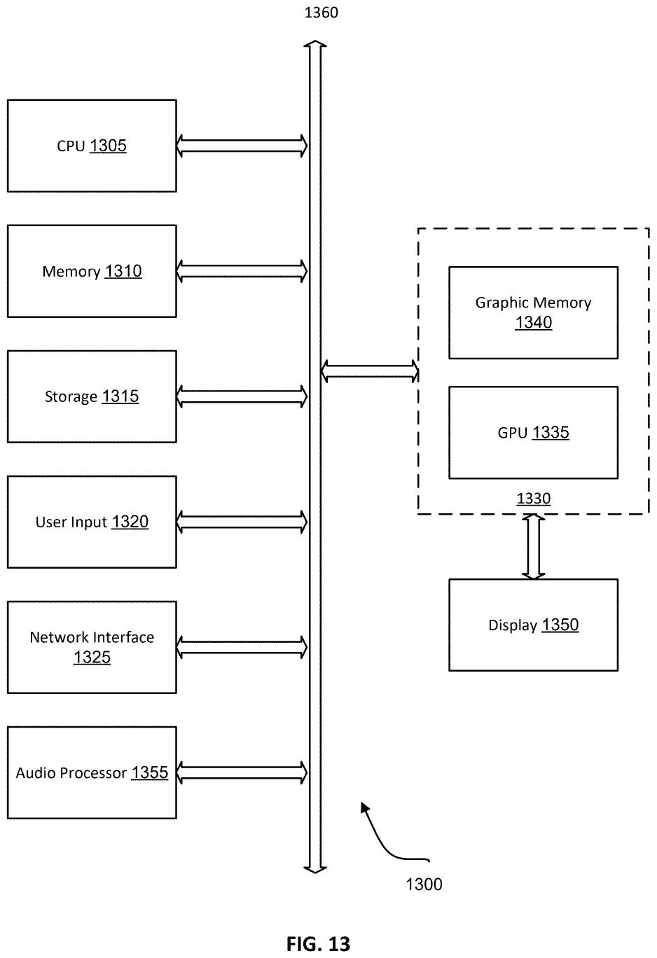

FIG. 13 illustrates an example of a hardware system suitable for implementing a computer system, according to embodiments of the present disclosure. The computer system 1300 represents, for example, a video game system, a backend set of servers, or other types of a computer system. The computer system 1300 includes a central processing unit (CPU) 1305 for running software applications and optionally an operating system. The CPU 1305 may be made up of one or more homogeneous or heterogeneous processing cores. Memory 1310 stores applications and data for use by the CPU 1305. Storage 1315 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 1320 communicate user inputs from one or more users to the computer system 1300, examples of which may include keyboards, mice, joysticks, touch pads, touch screens, still or video cameras, and/or microphones. Network interface 1325 allows the computer system 1300 to communicate with other computer systems via an electronic communications network, and may include wired or wireless communication over local area networks and wide area networks such as the Internet. An audio processor 1355 is adapted to generate analog or digital audio output from instructions and/or data provided by the CPU 1305, memory 1310, and/or storage 1315. The components of computer system 1300, including the CPU 1305, memory 1310, data storage 1315, user input devices 1320, network interface 1325, and audio processor 1355 are connected via one or more data buses 1360.

A graphics subsystem 1330 is further connected with the data bus 1360 and the components of the computer system 1300. The graphics subsystem 1330 includes a graphics processing unit (GPU) 1335 and graphics memory 1340. The graphics memory 1340 includes a display memory (e.g., a frame buffer) used for storing pixel data for each pixel of an output image. The graphics memory 1340 can be integrated in the same device as the GPU 1335, connected as a separate device with the GPU 1335, and/or implemented within the memory 1310. Pixel data can be provided to the graphics memory 1340 directly from the CPU 1305. Alternatively, the CPU 1305 provides the GPU 1335 with data and/or instructions defining the desired output images, from which the GPU 1335 generates the pixel data of one or more output images. The data and/or instructions defining the desired output images can be stored in the memory 1310 and/or graphics memory 1340. In an embodiment, the GPU 1335 includes 3D rendering capabilities for generating pixel data for output images from instructions and data defining the geometry, lighting, shading, texturing, motion, and/or camera parameters for a scene. The GPU 1335 can further include one or more programmable execution units capable of executing shader programs.

The graphics subsystem 1330 periodically outputs pixel data for an image from the graphics memory 1340 to be displayed on the display device 1350. The display device 1350 can be any device capable of displaying visual information in response to a signal from the computer system 1300, including CRT, LCD, plasma, and OLED displays. The computer system 1300 can provide the display device 1350 with an analog or digital signal.

In accordance with various embodiments, the CPU 1305 is one or more general-purpose microprocessors having one or more processing cores. Further embodiments can be implemented using one or more CPUs 1305 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 76%, 135%, 90%, 100%, 105%, 109%, 109.9% or, depending on the context within which the term substantially appears, value otherwise as known in the art.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method comprising:
accessing information indicating a first correspondence between a first three-dimensional landmark of a source three-dimensional face mesh representing a first face and a second three-dimensional landmark of a target three-dimensional head mesh representing a second face, the first three-dimensional landmark and the second three-dimensional landmark corresponding to a facial feature;
accessing a two-dimensional face image representing a third face, the two-dimensional face image further showing the facial feature; and
generating a three-dimensional head mesh based on the two-dimensional face image and the first correspondence between the first three-dimensional landmark and the three-dimensional second landmark, the three-dimensional head mesh representing a fourth face and including a first facial characteristic of the second face and a second facial characteristic of the third face.

2. The method of claim 1, the method further comprising:
determining a second correspondence between a first two-dimensional landmark of a first two-dimensional facial rendering representing the first face and a second two-dimensional landmark of a second two-dimensional facial rendering representing the second face;
determining the first three-dimensional landmark based on the first two-dimensional landmark; and
determining the second three-dimensional landmark based on the second two-dimensional landmark, wherein the first correspondence is based on the second correspondence.

3. The method of claim 2, wherein the method further comprises:
accessing the source three-dimensional face mesh;
accessing target three-dimensional head mesh;
generating, using a rasterization technique, the first two-dimensional facial rendering based on the source three-dimensional face mesh; and
generating, using the rasterization technique, the second two-dimensional facial rendering based on the target three-dimensional head mesh, wherein the first two-dimensional facial rendering is transformed back to the source three-dimensional face mesh using an inverse rasterization technique prior to accessing information indicating the first correspondence, and wherein the second two-dimensional facial rendering is transformed back to the target three-dimensional head mesh using the inverse rasterization technique prior to accessing information indicating the first correspondence.

4. The method of claim 1, wherein the method further comprises:
processing the two-dimensional face image to determine a geometry of the third face, an expression of the third face, and a pose of the third face; and
generating a candidate three-dimensional face mesh based on the two-dimensional face image, the geometry of the third face, the expression of the third face, and the pose of the third face, wherein the three-dimensional head mesh is generated based on using a deformation technique on the candidate three-dimensional face mesh.

5. The method of claim 1, wherein the three-dimensional head mesh is a target three-dimensional head mesh, and wherein the method further comprises:
accessing the target three-dimensional head mesh;
determining a defect at a vertex of the target three-dimensional head mesh;
determining a set of vertices of the target three-dimensional head mesh based on the vertex, wherein the set of vertices comprises the vertex; and
processing, using a smoothing technique, the set of vertices to mitigate the defect.

6. The method of claim 5, wherein the set of vertices is determined based on a connectivity to the vertex.

7. The method of claim 5, wherein the set of vertices is determined based on a distance from the vertex.

8. The method of claim 1, wherein the third face a real-world face, and wherein the second face is a video game character face.

9. The method of claim 1, wherein the third face a first video game character face, and wherein the second face is a second video game character face.

10. A computer system comprising:
processor circuitry; and
one or more computer-readable media comprising a sequence of instructions that, when executed, cause the processor circuitry to:
access information indicating a first correspondence between a first three-dimensional landmark of a source three-dimensional face mesh representing a first face and a second three-dimensional landmark of a target three-dimensional head mesh representing a second face, the first three-dimensional landmark and the second three-dimensional landmark corresponding to a facial feature;
access a two-dimensional face image representing a third face, the two-dimensional face image further showing the facial feature; and
generate a three-dimensional head mesh based on the two-dimensional face image and the first correspondence between the first three-dimensional landmark and the three-dimensional second landmark, the three-dimensional head mesh representing a fourth face and including a first facial characteristic of the second face and a second facial characteristic of the third face.

11. The computer system of claim 10, wherein the sequence of instructions that, when executed, further cause the processor circuitry to:
determine a second correspondence between a first two-dimensional landmark of a first two-dimensional facial rendering representing the first face and a second two-dimensional landmark of a second two-dimensional facial rendering representing the second face;
determine the first three-dimensional landmark based on the first two-dimensional landmark; and
determine the second three-dimensional landmark based on the second two-dimensional landmark, wherein the first correspondence is based on the second correspondence.

12. The computer system of claim 11, wherein the sequence of instructions that, when executed, further cause the processor circuitry to:
access the source three-dimensional face mesh;
access target three-dimensional head mesh;
generate, using a rasterization technique, the first two-dimensional facial rendering based on the source three-dimensional face mesh; and
generate, using the rasterization technique, the second two-dimensional facial rendering based on the target three-dimensional head mesh, wherein the first two-dimensional facial rendering is transformed back to the source three-dimensional face mesh using an inverse rasterization technique prior to accessing information indicating the first correspondence, and wherein the second two-dimensional facial rendering is transformed back to the target three-dimensional head mesh using the inverse rasterization technique prior to accessing information indicating the first correspondence.

13. The computer system of claim 11, wherein the sequence of instructions that, when executed, further cause the processor circuitry to:
process the two-dimensional face image to determine a geometry of the third face, an expression of the third face, and a pose of the third face; and
generate a candidate three-dimensional face mesh based on the two-dimensional face image, the geometry of the third face, the expression of the third face, and the pose of the third face, wherein the three-dimensional head mesh is generated based on using a deformation technique on the candidate three-dimensional face mesh.

14. The computer system of claim 13, wherein the three-dimensional head mesh is a target three-dimensional head mesh, and wherein the sequence of instructions that, when executed, further cause the processor circuitry to:
access the target three-dimensional head mesh;
determine a defect at a vertex of the target three-dimensional head mesh;
determine a set of vertices of the target three-dimensional head mesh based on the vertex, wherein the set of vertices comprises the vertex; and
process, using a smoothing technique, the set of vertices to mitigate the defect.

15. The computer system of claim 14, wherein the set of vertices is determined based on a connectivity to the vertex.

16. The computer system of claim 14, wherein the set of vertices is determined based on a distance from the vertex.

17. The computer system of claim 10, wherein the third face a real-world face, and wherein the second face is a video game character face.

18. The computer system of claim 10, wherein the third face a first video game character face, and wherein the second face is a second video game character face.

19. One or more computer-readable media comprising a sequence of instructions that, when executed, cause processor circuitry to:
access information indicating a first correspondence between a first three-dimensional landmark of a source three-dimensional face mesh representing a first face and a second three-dimensional landmark of a target three-dimensional head mesh representing a second face, the first three-dimensional landmark and the second three-dimensional landmark corresponding to a facial feature;
access a two-dimensional face image representing a third face, the two-dimensional face image further showing the facial feature; and
generate a three-dimensional head mesh based on the two-dimensional face image and the first correspondence between the first three-dimensional landmark and the three-dimensional second landmark, the three-dimensional head mesh representing a fourth face and including a first facial characteristic of the second face and a second facial characteristic of the third face.

20. The one or more computer-readable media of claim 19, wherein the sequence of instructions that, when executed, further cause processor circuitry to:
determine a second correspondence between a first two-dimensional landmark of a first two-dimensional facial rendering representing the first face and a second two-dimensional landmark of a second two-dimensional facial rendering representing the second face;
determine the first three-dimensional landmark based on the first two-dimensional landmark; and
determine the second three-dimensional landmark based on the second two-dimensional landmark, wherein the first correspondence is based on the second correspondence.
